(19) United States
(12) Patent Application Publication
(10) Pub. No.: US 2021/0012974 A1
(43) Pub. Date: Jan. 14, 2021

(54) FULLY-PRINTED ALL-SOLID-STATE ORGANIC FLEXIBLE ARTIFICIAL SYNAPSE FOR NEUROMORPHIC COMPUTING

(71) Applicant: UNIVERSITY OF SOUTHERN CALIFORNIA, LOS ANGELES, CA (US)

(72) Inventors: CHONGWU ZHOU, ARCADIA, CA (US); XUAN CAO, LOS ANGELES, CA (US); QINGZHOU LIU, LOS ANGELES, CA (US); YIHANG LIU, PASADENA, CA (US)

(21) Appl. No.: 16/928,657

(22) Filed: Jul. 14, 2020

Related U.S. Application Data
(60) Provisional application No. 62/873,928, filed on Jul. 14, 2019.

(51) Int. Cl. H01G 9/22; H01G 9/028; H01G 9/042; H01G 9/26; H01G 9/00; G06N 3/063; G06N 3/08

(52) U.S. Cl. CPC H01G 9/22; H01G 9/028; H01G 9/042; G06N 3/049; H01G 9/0036; G06N 3/0635; G06N 3/08; H01G 9/26

(57) ABSTRACT

The experimental realization of a non-volatile artificial synapse using organic polymers in a scalable fabrication process is provided. The three-terminal electrochemical neuromorphic device successfully emulates the key features of biological synapses: long-term potentiation/depression, spike-timing-dependent plasticity learning rule, paired-pulse facilitation, and ultralow energy consumption. The artificial synapse network exhibits excellent endurance against bending tests and enables a direct emulation of logic gates, which shows the feasibility of using them in futuristic hierarchical neural networks. Based on the demonstration of 100 distinct, non-volatile conductance states, high accuracy in pattern recognition and face classification neural network simulations is achieved.

### CROSS-REFERENCE TO RELATED APPLICATIONS

This application claims the benefit of U.S. provisional application Ser. No. 62873928 filed Jul. 14, 2019, the disclosure of which is hereby incorporated in its entirety by reference herein.

### TECHNICAL FIELD

In at least one aspect, the present invention is related to printed neuromorphic devices.

### BACKGROUND

The human brain can manage efficient information processing, learning and memory with extremely low energy-consumption. Artificial intelligence (e.g. AlphaGo) based on multi-core chips with traditional CMOS (complementary-metal-oxide-semiconductor) has exhibited the revolutionary computing power of neural networks.^{1, 2} However, due to the physical separation of computing and memory units (von Neumann bottleneck), traditional CMOS devices and circuits are not ideal for neuromorphic computing in regard to energy consumption and design complexity.³ Inspired by synaptic activity in biological processes, electronic devices with tunable resistance, such as memristors,⁴⁻¹³ phase-change memory,¹⁴⁻¹⁶ field-effect transistors,^{17, 18} spintronic,¹⁹⁻²¹ and ferroelectric devices,^{22, 23} have been widely demonstrated to emulate synaptic operations, including long-term potentiation/depression (LTP/LTD), short-term potentiation/depression (STP/STD), and low power consumption, with the device conductance representing the synaptic weight. Although memristors have been developed as non-volatile resistive random-access memory with high endurance and fast read/write abilities,^{24, 25} these devices cannot achieve long retention time and low-power switching at the same time.

Organic electrochemical devices can overcome the above dilemma with a unique switching mechanism.²⁶⁻²⁸ A recently developed conductance-tuning mechanism^{26, 29, 30} can make organic electronic devices work as a battery: upon applying an electric voltage pulse to the device, the proton concentration in the channel material changes due to redox reaction, thus, changing the film conductance; a counter-redox reaction in the gate can keep electrical neutrality through the device. As a result, the proton concentration in the organic film changes, thus, film conductance changes. Due to their biocompatibility, low-power consumption, and flexibility, organic memristive devices have great potential to act as memory and perform analogue information processing in wearable electronics and brain-machine interface applications.^{26, 29-31}

In spite of the great potential of using organic electrochemical devices for neuromorphic computing, the progress has been hindered by the difficulty in making such device. Previous demonstrations were often limited to single or a few devices and those devices were usually bulky in size or may even involve the use of liquid electrolyte, making integration of arrays of devices nearly impossible.

### SUMMARY

In at least one aspect, the present invention demonstrates the use of screen printing to produce an array of all-solid, three-terminal neuromorphic devices with a layer of polydiallyldimethylammonium chloride (PDADMAC) electrolyte on top of two poly(3,4-ethylene dioxythiophene):polystyrene sulfonate (PEDOT:PSS) films. Screen printing is a cost-effective and scalable technology compatible with organics with high throughput and low-temperature processing.^{32, 33} The fabricated devices can successfully emulate the basic characteristics of biological synapses, including long-term potentiation/depression, spike-timing-dependent plasticity (STDP), paired-pulse facilitation (PPF), and ultralow energy consumption. Our all-solid-state devices pave the way to low-cost and highly scalable fabrication of flexible neuromorphic device arrays, which would allow the integration of electronics with on-board computing and learning capability in implantable prosthetics or other wearable electronic systems. Furthermore, the demonstrated flexibility of the devices shows the potential for three-dimensional integrated system.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIGS. 1A and 1B. A) top view of a neuromorphic device and B) cross section view of neuromorphic device.

FIGS. 2A, 2B, 2C, 2D, 2E, 2F, and 2G. Fully-printed organic neuromorphic devices. A) Schematic illustration of the key fabrication procedures for organic neuromorphic devices with printing technology. B), C) Schematic showing switching mechanism in “read” and “write” operations in the organic neuromorphic devices. During the “read” operation (left), the external switch is open to forbid electron flow, leading to a stable channel conductance. During the “write” operation (right), the external switch is closed, permitting electrons to flow in and out of the gate, resulting in changes of channel conductance. D) Image of a device array with 45 organic neuromorphic devices. Scale bar is 1 cm. E), F) Magnified image of one device in the array, clearly showing the PEDOT:PSS layer before electrolyte layer patterning (E) and the PDADMAC film after patterning (F). Both scale bars represent 2 mm. G) Photograph of an array of organic neuromorphic devices on the flexible substrate while being bent. Scale bar is 1 cm.

FIGS. 3A, 3B, 3C, 3D, 3E, and 3F. Long-term neuromorphic behavior. A) Long-term potentiation and depression exhibiting 100 discrete states when the device is programmed with presynaptic pulses. The two insets are zoom-in plots showing the individual states. B) LTP/LTD cycling stress tests when the organic neuromorphic device is in a relaxed state (upper panel) and after 500 bending cycles (bottom panel). C) State retention for organic neuromorphic devices. The conductance is monitored for 10 seconds after a 1 s pulse is applied to change the states. The pulse amplitudes are as labeled. Different pulse amplitude can switch the conductance into different states, and after a pulse with an amplitude equal to the initial one, the conductance switched back to the state similar to the initial one. D) Retention of the HRS and LRS currents at Vₚₒₛₜ=100 mV and Vₚᵣₑ=0 V in an eight-hour period. E) Schematic showing the electrical implementation for STDP measurement. The organic neuromorphic device is connected between a pre-synaptic spike generator and a post-synaptic spike generator. F) STDP behavior of the device stimulated with a pair of spikes with different values of Δt.

FIGS. 4A, 4B, 4C, 4D, and 4E. Paired-pulse facilitation. A) Schematic showing the electrical setup for PPF measurement. Two pre-synaptic spike generators are probed on the pre-synaptic electrode. The inset shows the recorded waveform of pulses applied to the devices. The pulse amplitude is 50 mV, the pulse width is 25 ms, and the spiking timing Δt is ranging from 1 ms to 500 ms. B) Post-synaptic current with different spike timing. C) Post-synaptic weight changes triggered by a paired-pulse with time interval of 25 ms. G₁ and G₂ represent the conductance change of the first pulse and the second pulse, respectively. ΔG equals the difference between G₂ and G₁. D) Paired pulse facilitation with different time intervals. An exponential fit is applied to obtain two characteristic time scales. E) Switching energy measured as a function of device area. The slope of the linear fit is 20.5 nJ/mm².

FIGS. 5A, 5B, 5C, and 5D. Logic circuits based on neuromorphic devices. a) b) Schematic diagram showing the circuits used for logic gates, AND gate (series connection) and OR gate (parallel connection), respectively. c) The change of the AND gate conductance depends on the presynaptic inputs. When the presynaptic signals only came from synapse 1 or synapse 2, the conductance change did not reach the threshold line. When both synapses fired, the change of conductance passed the threshold line. d) For OR gate, even when a single synapse fired, the change of conductance slightly passed the threshold line.

FIGS. 6A, 6B, 6C, 6D, 6E, and 6F. Simulation of organic neuromorphic device-based neural networks. A) Schematic illustration of the implementation learning for pattern recognition. B) Schematic illustration of the architectural neural network with fabricated three-terminal devices. C) Conductance variation (ΔG) as a function of the conductance states showing the switch statistics of neuromorphic devices during long-term potentiation (light squares) and depression (dark squares). D), E) Backpropagation training results using Optical Recognition of Handwritten Digits and MNSIT database handwritten digits data-sets in the format of 8×8 pixel digit image (D) and 28×28 pixel digit image (E). F) Backpropagation training results for face recognition using the AT&T Laboratories Cambridge ORL database of faces.

FIGS. 7A, 7B, 7C, and 7D. Surface modification with oxygen plasma. Contact angles of water on unmodified PET substrate (A), on oxygen plasma-modified PET (B), on unmodified silver conductive film (C), and on oxygen plasma-modified silver conductive film (D). After being treated with oxygen plasma (100 W, 150 mTorr) for 30 seconds, the contact angle of water changes from 71° to 30° on PET substrate, and from 138° to 89° on silver film, which indicates the surface of both PET and silver film become more hydrophilic.

FIG. 8. Oxidation and reduction reaction of an PEDOT:PSS based all-solid organic neuromorphic devices. The molecular structures of PEDOT:PSS and PDADMAC are illustrated in this figure. Upon applying a negative Vpre to the PEDOT:PSS electrode, protons flow from the postsynaptic electrode into the presynaptic electrode through PDADMAC electrolyte, resulting in deprotonation of the PEI, and further cause the oxidation of PEDOT due to charge neutrality. This causes holes to be generated on the PEDOT backbone, thereby reducing the electronic resistivity of the postsynaptic electrode. The reaction is reversed when applying a positive presynaptic potential. The charge transfer is marked in red in the figure.

FIGS. 9A and 9B. Flexibility and uniformity study. (A) Electrical stability of neuromorphic devices under 500 mechanical bending cycles. In this measurement, the sample was bent with a radius of curvature of 10 mm for 100 cycles. Each bending cycle included one compression and one extension of the functional film. After every 5 bending cycles, positive and negative pulses were applied to measure the electrical properties of the device. The low- and the high-resistance states were recorded, respectively. This result shows that the flexible artificial synapse exhibits outstanding mechanical deformation endurance. (B) LTP and LTD were performed on 50 devices with same geometry. For each measurement, 100 positive pulses followed with 100 negative pulses were applied to each device and the conductance was recorded. The results show the good uniformity of our devices and demonstrate the reliability of using printing to fabricate such neuromorphic devices.

FIGS. 10A and 10B. Change in postsynaptic conductance as a function of presynaptic pulse duration (A) and amplitude (B). The measured excitatory post-synaptic currents (EPSC) are converted into conductance change (ΔG) of the post-synaptic electrode. With the presynaptic voltage fixed at 20 mV, the ΔG values increases from 0.5 μS (inset) to 371 μS for spike duration ranges from 10 ms to 8 s, respectively. The spike voltage-dependent EPSCs are also studied. With the presynaptic pulse duration fixed at 2 s, the ΔG increases from 48 μS to 251 μS for spike voltage ranges from 10 mV to 50 mV. As the linear fitting shown in both figures (in red), the conductance change is a linear function of presynaptic pulse duration and voltage.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of.” Typically, this phrase is used to denote that an object is formed from a material.

With respect to the terms “comprising,” “consisting of,” and “consisting essentially of,” where one of these three terms is used herein, the presently disclosed and claimed subject matter can include the use of either of the other two terms.

The term “one or more” means “at least one” and the term “at least one” means “one or more.” The terms “one or more” and “at least one” include “plurality” as a subset.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the invention can be obtained within a range of +/−5% of the indicated value.

As used herein, the term “and/or” means that either all or only one of the elements of said group may be present. For example, “A and/or B” shall mean “only A, or only B, or both A and B”. In the case of “only A”, the term also covers the possibility that is absent i.e. “only A, but not B”.

Throughout this application, where publications are referenced, the disclosures of these publications in their entireties are hereby incorporated by reference into this application to more fully describe the state of the art to which this invention pertains.

Abbreviations:

“LTP” means long-term potentiation.

“LTD” means long-term depression.

“PDADMAC” means polydiallyldimethylammonium chloride.

“PEDOT:PSS” means poly(3,4-ethylene dioxythiophene):polystyrene sulfonate.

“PET” means polyethylene terephthalate.

“PPF” means paired-pulse facilitation.

“STP” means potentiation.

“STD” means short-term depression.

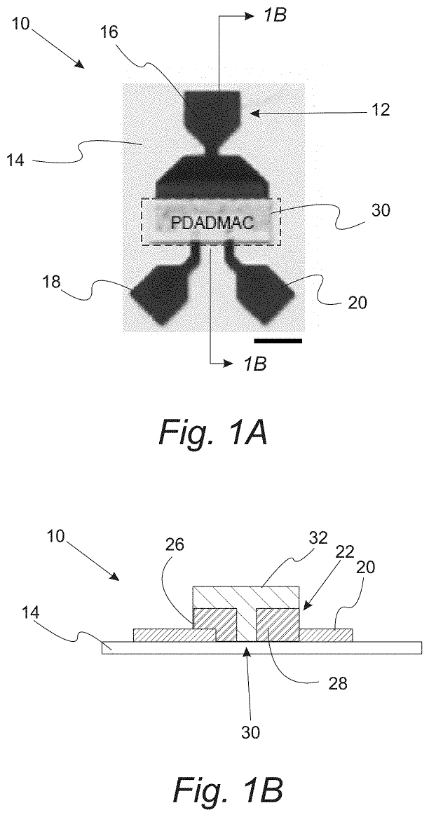

With reference to FIG. 1, schematics of a neuromorphic device are provided. Neuromorphic device 10 includes a patterned electrical contact 12 disposed on a substrate 14. Typically, substrate 14 is a flexible polymeric substrate. Patterned electrical contact 12 defines a presynaptic contact section 16, a first post-synaptic contact section 18, and a second post-synaptic contact section 20. Characteristically, the presynaptic contact section 16, the first post-synaptic contact section 18, and the second post-synaptic contact section 20 are electrically separated from each other.

Neuromorphic device 10 also includes a patterned layer 22 of an electrically conductive polymer having a first polymeric section 26 disposed over a portion of the presynaptic contact section 16 and a second polymeric section 28 disposed over the first post-synaptic contact section 18 and the second post-synaptic contact section 20. Characteristically, the electrically conductive polymer having an electrical conductivity that can be tuned by localization or delocalization of electrons therein, the first polymeric section and the second polymeric section being separated to define a gap 30. In a refinement, the patterned layer of an electrically conductive polymer is a polymeric salt. An example of a material that can be used for the electrically conductive polymer is poly(3,4-ethylene dioxythiophene):polystyrene sulfonate.

Neuromorphic device 10 also includes polyelectrolyte layer 32 disposed over the both the first polymeric section 26 and the second polymeric section 28 and at least partially filling the gap 30. An example of a material that can be sued for the polyelectrolyte layer is polydiallyldimethyl-ammonium chloride. As set forth below in more detail, when no voltage is applied to the presynaptic contact section 16 the neuromorphic device is in a low electrical conductivity state and when a positive voltage (e.g., relative to ground) is applied to the presynaptic contact section 16 the neuromorphic device switches to a high electrical conductivity state. In a refinement, a negative voltage applied to the presynaptic contact section causes the neuromorphic device to return to the low electrical conductivity state after a positive voltage has been applied.

As set forth below in more detail, an array of neuromorphic devices can be constructed to form a number of different circuits having one or more logic gates. In these arrays, a subset of the array of neuromorphic devices are connected in parallel and/or in series.

In another embodiment, a method for making the neuromorphic device set forth above is provided. The method includes a step of screen-printing a patterned electrical contact 12 on a substrate 14. Patterned electrical contact 12 defines a presynaptic contact section 16, a first post-synaptic contact section 18, and a second post-synaptic contact section 20. Characteristically, the presynaptic contact section 16, the first post-synaptic contact section 18, and the second post-synaptic contact section 20 are electrically separated from each other. Next, a patterned layer 22 of an electrically conductive polymer is screen-printed such that a first polymeric section 26 is screen-printed over a portion of the presynaptic contact section 16 and a second polymeric section 28 is screen-printed over the first post-synaptic contact section 18 and the second post-synaptic contact section 20. Finally, polyelectrolyte layer 32 is screen-printed over the both the first polymeric section 26 and the second polymeric section 28 at least partially filling the gap 30. In a variation, an array of neuromorphic devices is formed. In a refinement, such an array is formed by forming multiple components (e.g., patterned electrical contact 12, patterned layer 22, and polyelectrolyte layer 32) in parallel during the screen printing steps. Moreover, details of patterned electrical contact 12, patterned layer 22, and polyelectrolyte layer 32 are the same for the method as set forth above.

Additional details of the present invention are found in Fully Printed All-Solid-State Organic Flexible Artificial Synapse for Neuromorphic Computing, Qingzhou Liu, Yihang Liu, Ji Li, Christian Lau, Fanqi Wu, Anyi Zhang, Zhen Li, Mingrui Chen, Hongyu Fu, Jeffrey Draper, Xuan Cao, and Chongwu Zhou ACS Applied Materials & Interfaces 2019 11 (18), 16749-16757 DOI: 10.1021/acsami.9b00226 and its supporting information; the entire disclosures of these documents are hereby incorporated by reference.

The following examples illustrate the various embodiments of the present invention. Those skilled in the art will recognize many variations that are within the spirit of the present invention and scope of the claims.

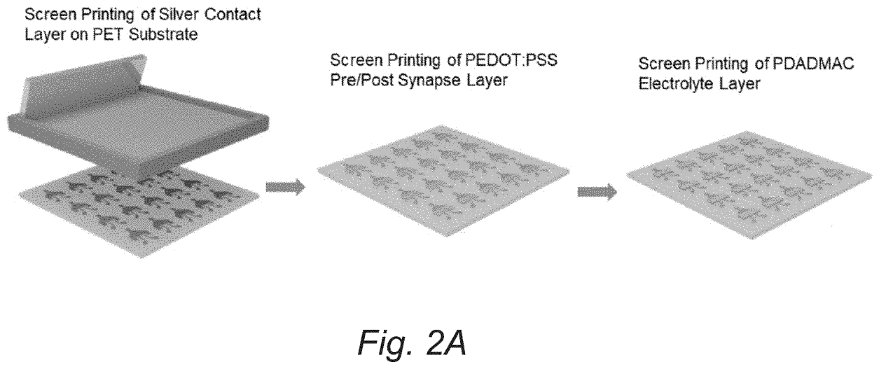

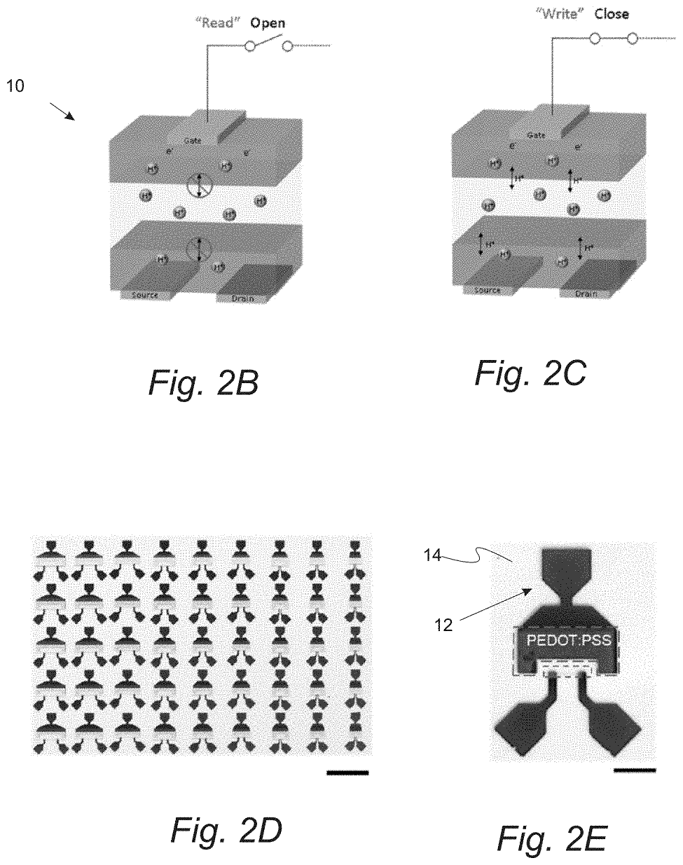

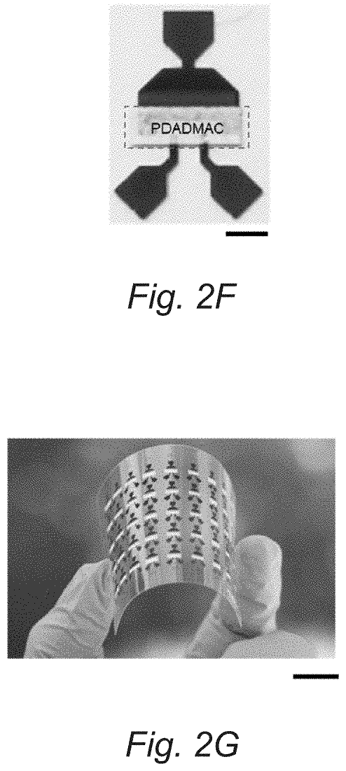

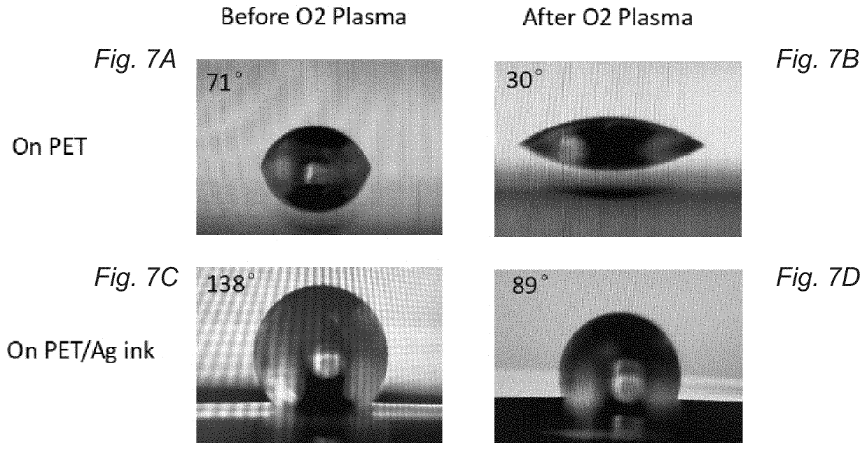

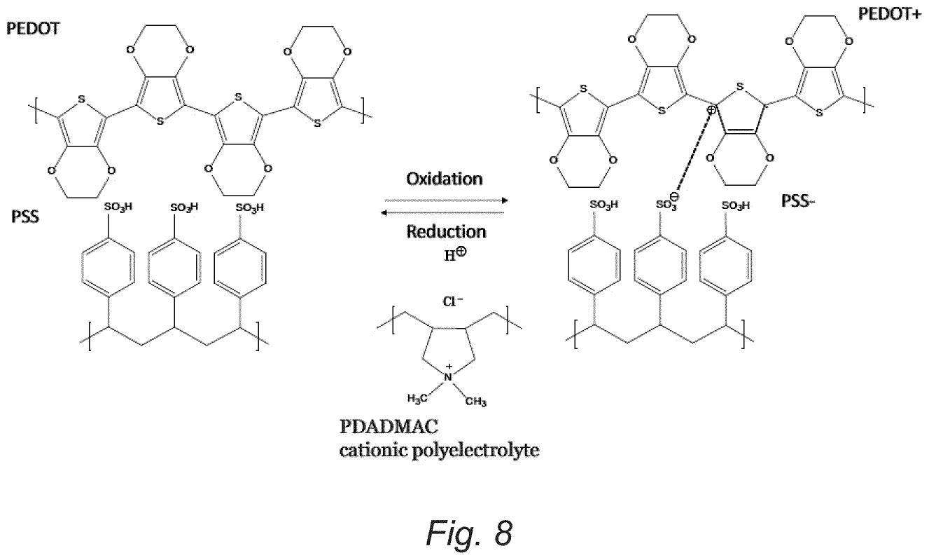

The fabrication process of our organic-based flexible neuromorphic devices is illustrated in FIG. 2A. We developed a 3-step printing process with high yield and high uniformity, using silver conductive ink as the metal contact, using PEDOT:PSS as the postsynaptic and presynaptic electrodes, and using PDADMAC film as the solid electrolyte. Silver nanoparticle ink was first printed through a screen mesh on a flexible polyethylene terephthalate (PET) substrate. To enable aqueous ink deposition, we modified the surface energy of the patterned silver layer and PET surface with oxygen plasma treatment (FIG. 7). A thin-film of water-based PEDOT:PSS dispersions was then screen printed as the active layer, followed by a double-layer printing of a thick layer of PDADMAC electrolyte. PEDOT is an electronic semiconductor degenerately doped by the ion-conducting electrical insulator PSS. The electrical conductivity of PEDOT:PSS based polymer can be tuned by localization or delocalization of electrons along the polymer backbone (FIG. 8), and the conductivity is considered as postsynaptic weight of the connection between two neuros, a key feature of a synapse. The device was laterally gated with a solid cationic polyelectrolyte layer, PDADMAC. Further details of the device fabrication are provided in the Experimental Section set forth below.

The programming (“read” and “write”) of the neuromorphic devices is similar to charging and discharging a battery. During a “read” operation, the external switch is open and there is no electric signal flow, and therefore the proton concentration remains unaltered in each layer, as exhibited in FIG. 2B. To achieve “write” operation, the switch is closed and a signal from the gate electrode is regarded as the presynaptic stimulus, as exhibited in FIG. 2C. When applying a positive presynaptic pulse Vₚᵣₑ, cations are injected into the postsynaptic electrode through the presynaptic electrode and the electrolyte. Thus, the organic device is switched to a high conductance stage since the number of holes is reduced in the postsynaptic electrode due to protonation of the PEDOT film. After this “write” step, the device is disconnected, and the energy barrier between the channel and electrolyte forbids electronic charge transport, keeping the electrode conductance state in a non-volatile way.

Using the screen printing process, we fabricated a sheet comprising a flexible array of 45 three-terminal neuromorphic devices (FIG. 2D), with a channel width of 100 μm and channel length ranging from 200 μm to 3 mm. In a magnified optical image of one device in the array with and without the PDADMAC layer (FIGS. 2E and 2F), all components are fully patterned and well aligned. Owing to the intrinsic flexibility of organic materials, the all-solid-state neuromorphic devices are fully compatible with flexible substrates (FIG. 2G), opening up opportunities to work as memory and analog information processor for wearable electronics.

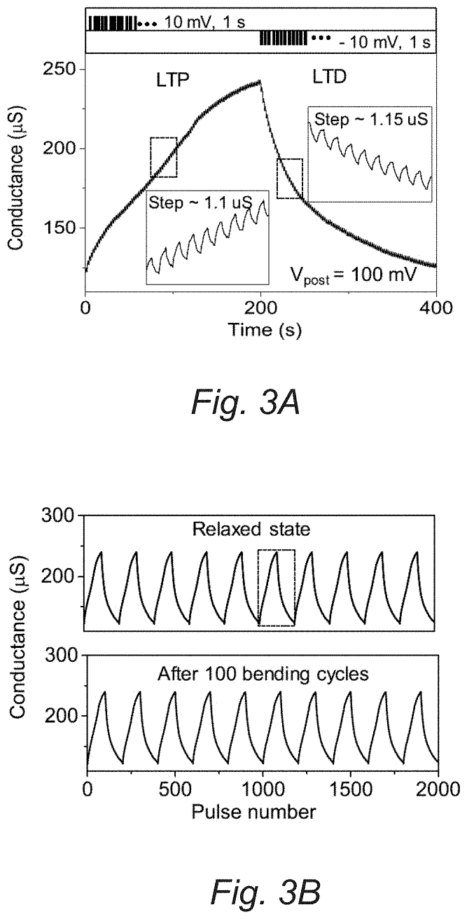

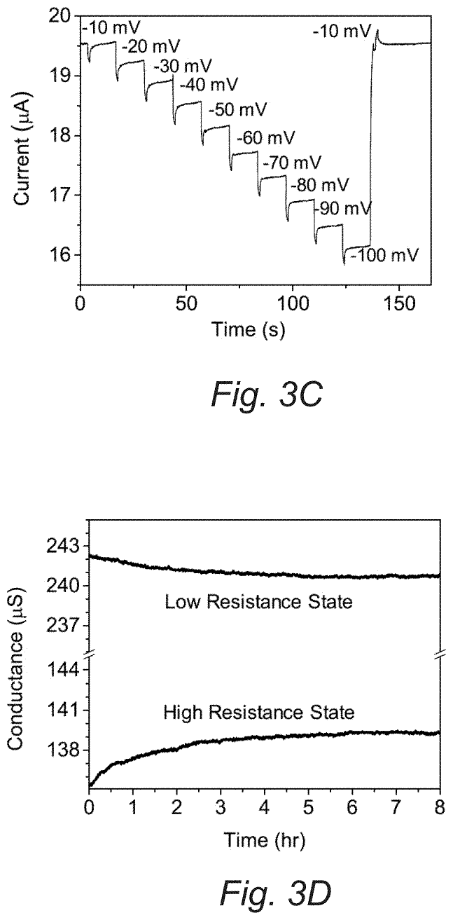

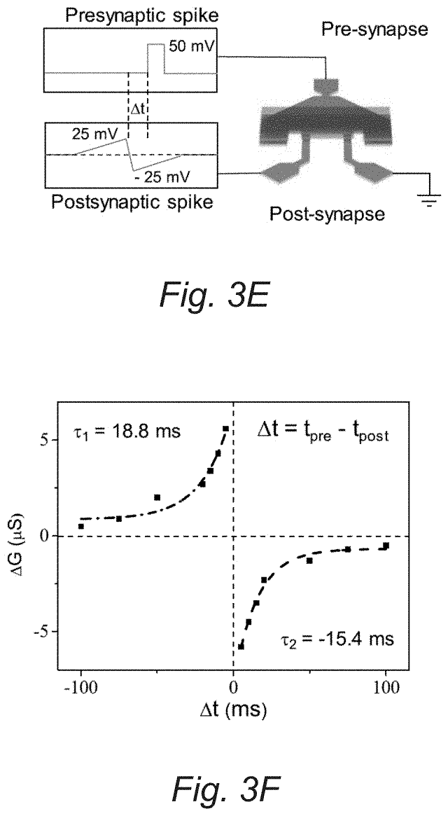

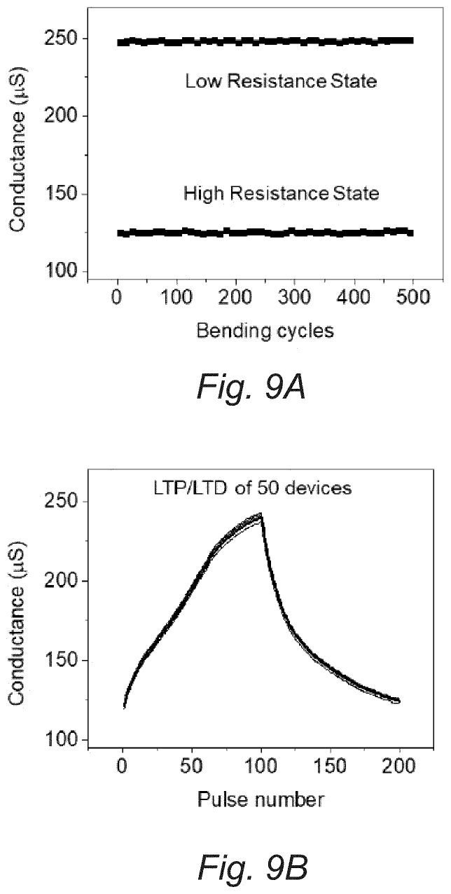

The long-term potentiation/depression (LTD/LTP) has been considered as one of the most important forms of plasticity that is closely related to the synaptic activity and signal transmission between two neurons.³⁴ To mimic excitatory and inhibitory synapses in organisms, the LTD/LTP behaviors of our organic neuromorphic devices are experimentally analyzed. FIG. 3A shows the result for a neuromorphic device (channel length=250 μm, channel width=100 μm) measured with a series of 100 identical positive pulses (10 mV, 1 s), followed by a series of 100 negative voltage pulses (−10 mV, 1 s). As the number of positive pulses increases, the device becomes more conductive, representing continuous tunability of 100 distinct conductance states. The inset images exhibit the discrete conductance states under LTD/LTP process with mean step ˜1.1 μS. After applying 100 negative pulses, the neuromorphic device restored to its initial low-conductance state. We cycled the device in the LTD/LTP process more than 10 times using the above method, as exhibited in FIG. 3B. The cycling data reveal good electrochemical stability, repeatability of the synaptic characteristics, as well as fine synaptic resolution (analog programmability). Because of the good flexibility and uniformity of the materials, the organic neuromorphic devices exhibit stable and reproducible potentiation-depression cyclic behavior, regardless of mechanical bending (FIG. 3B and FIG. 9).

It is worth noting that the changes in the synaptic weight is non-volatile, as shown in FIG. 3C, we programmed 10 pulses ranging from 10 mV to 100 mV, followed with ˜10 s relaxation time after each pulse. The current curve shows ten distinct conductance states, and during the “read” state after the pulse is applied, the conductance did not show a significant drop. The study continues with a signal identical to the first pulse, which eventually brings the device back to a state close to its initial state, indicating the good stability and reproducibility of our devices. To further demonstrate the non-volatility of our devices, we monitored 8-hour retention of both the low resistance state (LRS) and high resistance state (HRS) (FIG. 3D). Only ˜3 μS (˜1%) change in the synaptic weight was observed in the retention test, which demonstrates that our devices have excellent non-volatile long-term memory.

The synaptic strength in biological systems can be regulated by the timing and causality of pre- and post-synaptic spikes with the STDP rules, which is one of the fundamental rules for emulating synapses. For our devices, the observed STDP characteristics are similar to those in biological synapses. A pair of pulses were applied to the pre-synaptic electrode and post-synaptic electrode to work as pre-synaptic and post-synaptic spikes, respectively. The two pulses (50 mV, 25 ms) were separated by a time difference (spike timing), Δt, and a post-synaptic voltage (V_{read}=100 mV) was applied to record the conductance of the device when applying paired pulses (FIG. 3E). A summary of the conductance change (ΔG) of the devices with different value of spike timing (ranging from −100 ms to 100 ms) is shown in FIG. 3F. Judging from the results, the synaptic weights increased when the pre-synaptic pulse was applied shortly before post-synaptic pulse, and the synaptic weights decreased when the pre-synaptic pulse was applied shortly after post-synaptic pulse. The time constants extrapolated from the data are ˜18.8 ms and 15.4 ms, which are comparable to the response times of biological synapses.³⁵

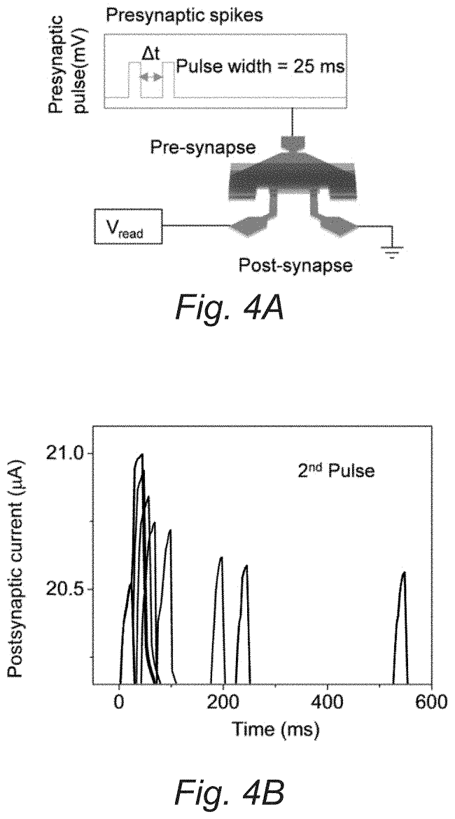

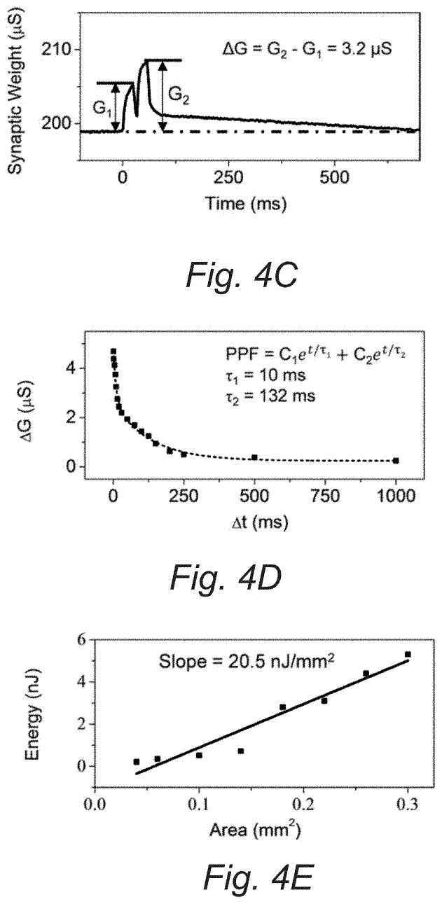

Paired-pulse facilitation (PPF) is an important form of short-term synaptic plasticity, which describes the phenomenon that the amplitude of a postsynaptic spike evoked by a pulse increased when that pulse closely follows a prior pulse. We realized PPF functions in our artificial synapse using two sequential pre-synaptic spikes (50 mV, 25 ms) with a time interval (Δt ranging from 1 to 500 ms) to emulate signals from different pre-synaptic neurons, as shown in FIG. 4A. It can be seen clearly from FIG. 4B that the amplitude of the second pulse is larger than that of the first one when Δt<100 ms because such short time interval is insufficient for the cations injected from the first pulse to return to the electrolyte layer before the second pulse arrives. For the time interval larger than 100 ms, there is enough time for the injected cations move back to the electrolyte, which means the paired pulses have a low degree of relevancy. Therefore, we can consider the spikes as two independent stimulations to the device, and no significant change in the synaptic strength occurs.

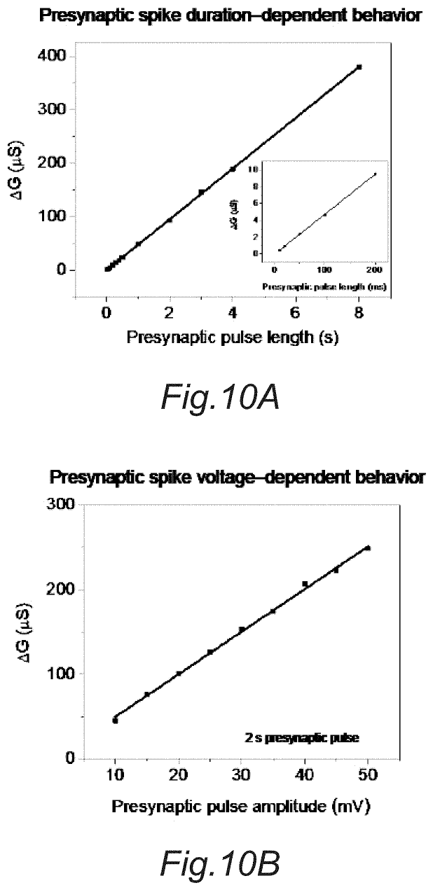

The PPF effect can be better illustrated by calculating the difference between the two conductance peaks generated by the first pulse (G₁) and the second pulse (G₂). A typical PPF curve of the organic device is shown in FIG. 4C. When the time interval between the paired pulses is 25 ms, the amplitude of the second postsynaptic peak was ˜3.2 μs higher than the amplitude triggered by the first spike. The dependence of the postsynaptic weight enhancement on the pulse interval (FIG. 4D) exhibits a similar trend to that observed in biological systems.³⁶ The two-phase behavior can be fitted well by a double exponential function: where Δt is the pulse interval time, C₁ and C₂ are the initial facilitation magnitudes of the respective phases, and τ₁ and τ₂ are the characteristic relaxation times of the respective phases. In the fitting, τ₁=10 ms and τ₂=240 ms, which are comparable to those of a biological synapse.³⁶ The conductance changes are proportional to the presynaptic pulse amplitude and duration (FIG. 10), indicating good analog programmability of the short-term synaptic plasticity.

The energy consumption for a single operation can be found by calculating the power dissipation at each time point (dE=V×I×dt) and taking an integral over the operation time. The switching energy is proportional to the channel area with a slope of 20.5 nJ/mm², as displayed in FIG. 4E. The power of the smallest device was measured to be ˜200 pJ, demonstrating the extraordinary low switching energy of our devices. In comparison, the energy consumption of 45 nm silicon CMOS devices is 931 μJ/mm² with supply voltage at 1.1 V. The hardware performance of silicon implementations is obtained by synthesizing with the 45 nm Nangate Open Cell Library³⁷ using Synopsys Design Compiler. The proposed flexible artificial synapses are suitable to be operated in ultra-low voltage regimes, indicating these devices have great potential for portable and low-power applications.

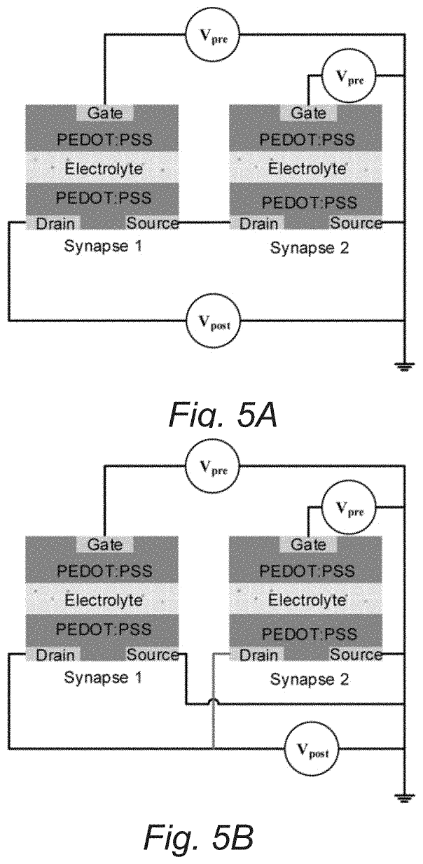

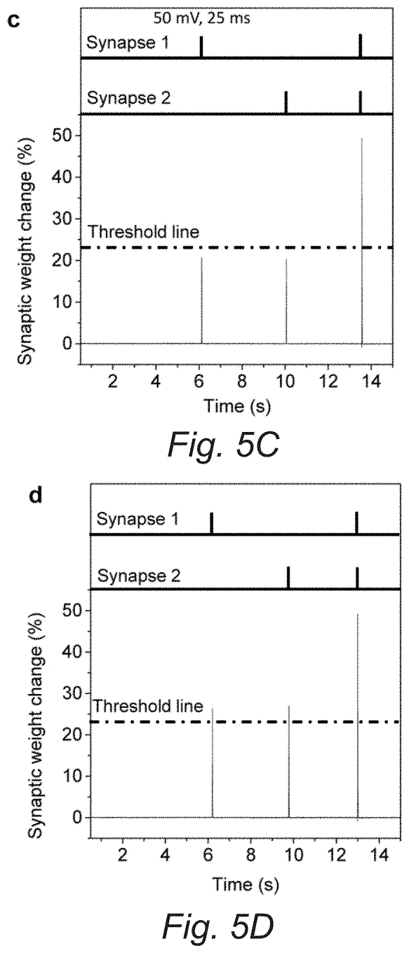

We can build logic gates by integration of two or more neuromorphic devices. FIGS. 5A and 5B show the schematic diagram of two artificial synapses connected in series and in parallel, respectively. The spiking signals (Vₚᵣₑ) from two pre-synapses are applied to the gates of the devices, then the signals summed in the dendrite of a post-synaptic neuron. As shown in FIG. 5C, with a pulse (50 mV, 25 ms) representing “1” and no pulse representing “0”, the binary inputs of “00”, “01”, “10”, and “11” were applied on synapse 1 and synapse 2, respectively. Only when input signals are “11”, the change of synaptic weight in the series connected devices is larger than the threshold value (24%), indicating the “AND” logic. For parallel connected devices, as long as one input voltage is “1”, the signal amplitude is larger than the threshold, indicating the “OR” logic (FIG. 5D). The realized AND and OR logic gates can have important implications in capturing the computing power of neural system where the nonlinear and analogue mechanisms are predominant.

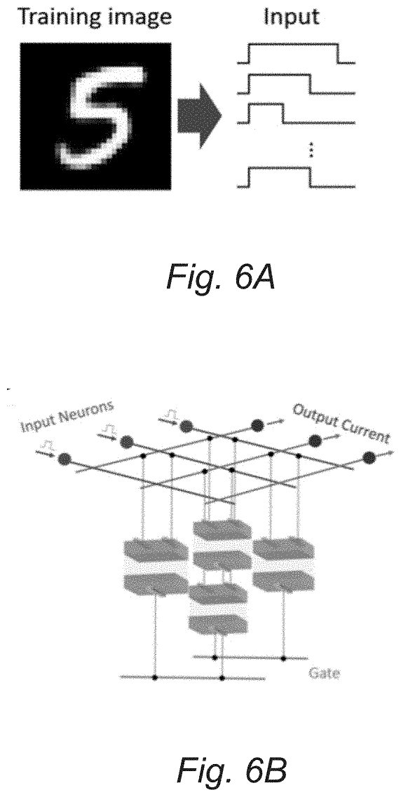

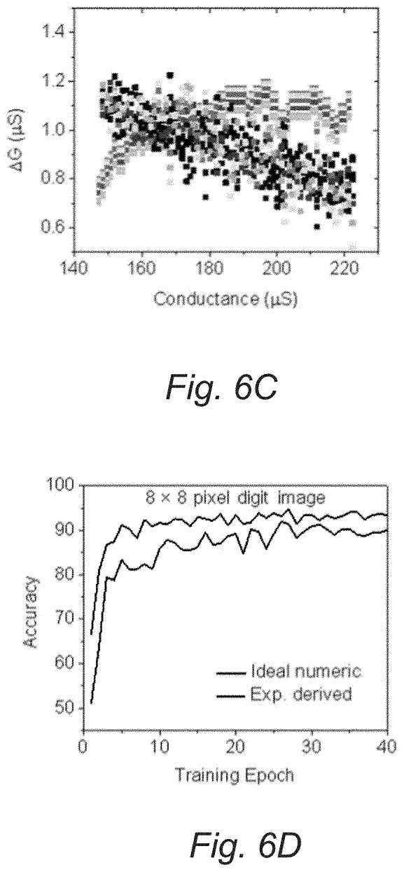

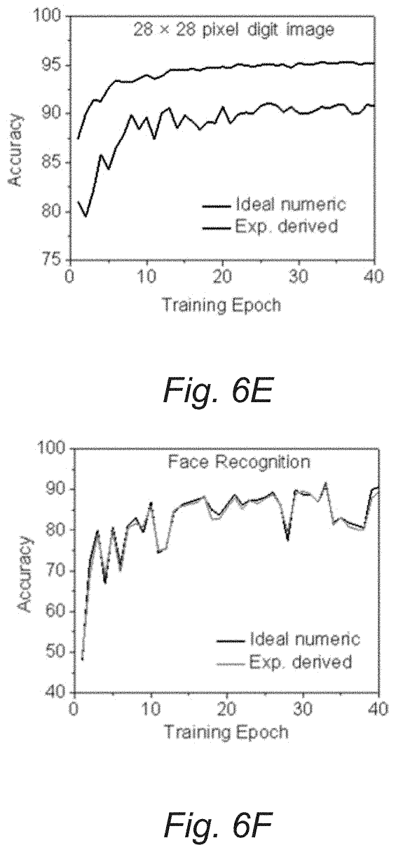

Furthermore, to fully illustrate the capability of the low noise and linearly programmable conductance states of our neuromorphic devices, we simulated a neural network based upon its experimentally measured properties, as illustrated in FIG. 6A: pixel signals of the training image were employed as the input for the simulation. The architecture of the neural network was described schematically in FIG. 6B: the devices in a row are arranged by connecting the transistor source to the same input line and connecting the transistor gate to the same gate line, while the devices in a column are arranged by connecting the drain to the same output line. The range of numerical weight values was linearly scaled to the range of conductance states of devices. To accurately account for the effects of device variations, we extracted experimental device conductance states from 10 linear potentiation and depotentiation cycles through the complete dynamic range based on more than 2000 experimentally measured states (FIG. 3B). The statistics of device variations were concluded in FIG. 6C. The measured non-linearity and write noise from FIG. 6C were fed into the software simulator such that the application evaluation considers device-induced numerical weight variations.

Using the designs presented so far, we performed holistic evaluation of neural networks based on our neuromorphic devices on three popular datasets for image recognition and face detection. Firstly, two databases of handwritten digits (Optical Recognition of Handwritten Digits³⁸ and MNIST³⁹) were evaluated. The Optical Recognition of Handwritten Digits database contains normalized bitmaps of handwritten digits from a total of 43 people, where 30 contributed to the training set and different 13 to the test set. 32×32 bitmaps are divided into non-overlapping blocks of 4×4 and the number of on pixels are counted in each block. A 64×50×10 network was configured for evaluation. Both ideal numeric and experimentally derived results were exhibited in FIG. 6D. The ideal numeric data presented an initial accuracy of 67.1%, which quickly raised to 87.0% at the third training epoch and stabilized at ˜90% from the 5^{th} to the 40^{th} epoch. With the similar trend, the experimentally derived curve presented an initial accuracy of 51.7%, and the accuracy was stabilized ˜88% after 40 epochs. On the other hand, MNSIT dataset consists of 60,000 training data and 10,000 testing data, and each entry is a 28×28 grayscale image. A deep neural network with 784×300×10 configuration was used to evaluate the network performance. Backpropagation and gradient descent optimizer were utilized during evaluation. As exhibited in FIG. 6E, accuracy of ˜95% and ˜90% was obtained for the ideal numeric and experimentally derived data after 40 training epochs. Owing to the exceptional linearity and low noise of our neuromorphic devices, the experimentally derived data is very close to the accuracy limitation presented by the simulated ideal data.

In addition, another dataset we used is the AT&T Laboratories Cambridge ORL database of faces,⁴⁰ which provides typical experimental setups for face recognition.⁴¹ The ORL database is comprised of 400 grayscale face images of size 92×112 pixels from 40 persons of different gender, ethnic background and age. For some subjects, the images were taken at different times, varying the lighting, facial expressions (open/closed eyes, smiling/not smiling) and facial details (glasses/no glasses). We first scaled the original image from 92×112 to 23×28 to significantly reduce the number of devices required in the first layer. The hidden layer contained 200 neurons and the output layer had 40 neurons. The face recognition result based on the ORL database is exhibited in FIG. 6F, and the experimentally derived data is almost identical to the simulated ideal data, the accuracy quickly raised to ˜80% within 3 training epochs and stabilized ˜85% after that, indicating our architectural network is a feasible and favorable route to the practical pattern recognition applications.

In conclusion, we demonstrate fully screen-printed, flexible, all-solid, three-terminal organic neuromorphic devices, which can act as non-volatile memory units and neuromorphic computing. The fabricated devices can behave like biological synapses and exhibit the characteristics of LTP/LTD, the STDP learning rule, PPF, and ultralow energy consumption. The demonstrated 100 almost linear and stable conductance states suit well with the analogue world, with no need of power -and time-inefficient analogue-to digital converters. The all-solid-state devices pave the way to low-cost fabrication of flexible neuromorphic device arrays, which enables correlated learning, multi-stage trainable memory, and integration of three-dimensional neural network. The results here provide an encouraging pathway toward biological synaptic emulation using printed organic devices for neuromorphic computing.

Materials. Silver conductive ink (AG-959) was obtained from Conductive Compounds, Inc. It was diluted with diethylene glycol ethyl ether acetate (Solvent 20) before printing. The PEDOT:PSS conductive ink (Clevios™ S V3.1) was stirred for at least 30 min to make it homogeneous. The electrolyte ink was prepared with poly(diallyldimethylammonium chloride) (weight-average molecular weight (M_{w})<100,000, Sigma-Aldrich), TiO₂ powder (Kronos 2300), and poly(ethylene glycol-ran-propylene glycol) (M_{w}˜12,000, Sigma-Aldrich) at a 5:4:1 weight ratio. The mixture was then bath-sonicated for 20 min and then probe sonicated for 25 min.

PEDOT:PSS neuromorphic device fabrication. Flexible, transparent PET substrate was cleaned with oxygen plasma (100 W, 150 mTorr) for 1 min, and then sonicated with acetone, 2-propanol and deionized water for 5 min each. After being blown dry with nitrogen gas, the substrate was attached to the sampler holder of a desktop screen printer (DP-320, Itochu). A layer of diluted silver ink was printed on the transparent PET at a clearance of 2 mm to work as metal contacts. The sample was then baked at 120° C. for 10 min. To enable following aqueous ink printing, the PET substrate and silver ink film were treated with oxygen plasma (100 W, 150 mTorr) for 30 s to became more hydrophilic, and it was verified with contact angle measurement (FIG. 8). Then, a single layer of the PEDOT:PSS paste was screen printed over the silver contact metal at a clearance of 2.75 mm. The sample was then baked at 60° C. for 10 min to remove excessive solvent. Subsequently, a double layer of the PDADMAC electrolyte was printed on top of the PEDOT:PSS and silver contact using clearance of 2.75 mm and baked at 60° C. for 10 min.

### Logic Gate Characterization

Two artificial synapses have been connected in series (AND gate) or in parallel (OR gate) (FIGS. 5A and 5B). Without any presynaptic voltage, the devices are at low presynaptic conductance, a logic state of “0”; with presynaptic pulses (50 mV, 25 ms), the devices are switched to more conductive states, work as logic state of “1”. The postsynaptic voltage was kept at 100 mV to monitor the change of conductance. The threshold line of the synaptic weight change is set at 23%, plotted as dashed line in both FIG. 5C and FIG. 5D.

### Image/Face Recognition Simulations

To evaluate the performance of our neuromorphic devices on practical large-scale neural networks, a software simulator was developed in Python with Numpy and TensorFlow¹. The device model was built using following method. We denoted the j-th neuron in the i-th layer as X_{i,j}, and its output is x_{i,j}. For each neural network of interest, the numerical weights were mapped directly onto the experimental device conductance states of the neuromorphic devices. More specifically speaking, for the b-th neuron X_{i,b} in the i-th layer of the neural network, each input weight w_{a,b}ⁱ⁻¹ between this neuron X_{i,b} and the connected neuron X_{j-1,a} in the previous layer was implemented with one device. Each weight value w_{a,b}ⁱ⁻¹ was mapped onto the corresponding conductance state of device. As a result, the multiplication x_{i-1,a}×w_{a,b}ⁱ⁻¹ was realized by applying voltage on the input of device to generate a current value, and the addition of all the products in neuron X_{i,b} (i.e., x_{i,b}=Σ_{∀j}x_{i-1,j}×w_{j,b}ⁱ⁻¹) was conducted by gathering all the current values. The range of numerical weight values was linearly scaled to the range of conductance states of device. To perform neural network simulation, each weight value w was first mapped to the closest conductance state G₀. Then noise was sampled from the probability distribution in FIG. 6C and added to calculate the actual conductance G₀′. For each neural network in our experiments, we generated 10 networks with noise introduced in each device and reported the averaged accuracy performance as the experimentally derived data. The details of data sets are summarized in Table 1.

TABLE 1
Parameters of datasets and neural networks

| | | Training | Testing | Neural network | |
|---|---|---|---|---|---|
| Dataset | Input size | examples | examples | configuration | Application |
| ORL | 23 × 28 | 240 | 160 | 644 × 100 × 40 | Face recognition |
| Optical Recognition of | 8 × 8 | 3823 | 1797 | 64 × 50 × 10 | Digit recognition |
| Handwritten Digits | | | | | |
| MNIST | 28 × 28 | 50000 | 10000 | 784 × 300 × 10 | Digit recognition |

Electrical characterization. Electrical characterization was performed using a semiconductor analyzer system (Agilent B1500 multi-channel measurement set-up), supplemented by two Agilent 33500B waveform generator and an Agilent DS01022A oscilloscope. All measurements were performed in an atmospheric environment at room temperature. During the electrical measurements, the pulses were applied to the Ag presynaptic contact with the postsynaptic channel monitored under 100 mV bias.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCES

1. Merolla, P. A.; Arthur, J. V.; Alvarez-Icaza, R.; Cassidy, A. S.; Sawada, J.; Akopyan, F.; Jackson, B. L.; Imam, N.; Guo, C.; Nakamura, Y.; Brezzo, B.; Vo, I.; Esser, S. K.; Appuswamy, R.; Taba, B.; Amir, A.; Flickner, M. D.; Risk, W. P.; Manohar, R.; Modha, D. S., Artificial brains. A million spiking-neuron integrated circuit with a scalable communication network and interface. Science 2014, 345, 668-73.

2. Silver, D.; Huang, A.; Maddison, C. J.; Guez, A.; Sifre, L.; van den Driessche, G.; Schrittwieser, J.; Antonoglou, I.; Panneershelvam, V.; Lanctot, M.; Dieleman, S.; Grewe, D.; Nham, J.; Kalchbrenner, N.; Sutskever, I.; Lillicrap, T.; Leach, M.; Kavukcuoglu, K.; Graepel, T.; Hassabis, D., Mastering the game of Go with deep neural networks and tree search. Nature 2016, 529, 484.

3. Backus, J., Can programming be liberated from the von Neumann style?: a functional style and its algebra of programs. ACM: 2007.

4. Strukov, D. B.; Snider, G. S.; Stewart, D. R.; Williams, R. S., The missing memristor found. Nature 2008, 453, 80-3.

5. Yang, J. J.; Pickett, M. D.; Li, X.; Ohlberg, D. A.; Stewart, D. R.; Williams, R. S., Memristive switching mechanism for metal/oxide/metal nanodevices. Nature nanotechnology 2008, 3, 429-33.

6. Kuzum, D.; Yu, S.; Wong, H. S., Synaptic electronics: materials, devices and applications. Nanotechnology 2013, 24, 382001.

7. Yang, J. J.; Strukov, D. B.; Stewart, D. R., Memristive devices for computing. Nature nanotechnology 2013, 8, 13-24.

8. Shulaker, M. M.; Hills, G.; Park, R. S.; Howe, R. T.; Saraswat, K.; Wong, H.-S. P.; Mitra, S., Three-dimensional integration of nanotechnologies for computing and data storage on a single chip. Nature 2017, 547, 74.

9. Sheridan, P. M.; Cai, F.; Du, C.; Ma, W.; Zhang, Z.; Lu, W. D., Sparse coding with memristor networks. Nature nanotechnology 2017, 12, 784-789.

10. Kim, S.; Choi, S.; Lu, W., Comprehensive physical model of dynamic resistive switching in an oxide memristor. ACS nano 2014, 8, 2369-2376.

11. Sheridan, P. M.; Cai, F.; Du, C.; Ma, W.; Zhang, Z.; Lu, W. D., Sparse coding with memristor networks. Nature nanotechnology 2017, 12, 784.

12. Wang, Z.; Joshi, S.; Savel'ev, S.; Song, W.; Midya, R.; Li, Y.; Rao, M.; Yan, P.; Asapu, S.; Zhuo, Y.; Jiang, H.; Lin, P.; Li, C.; Yoon, J. H.; Upadhyay, N. K.; Zhang, J.; Hu, M.; Strachan, J. P.; Barnell, M.; Wu, Q.; Wu, H.; Williams, R. S.; Xia, Q.; Yang, J. J., Fully memristive neural networks for pattern classification with unsupervised learning. Nature Electronics 2018, 1, 137-145.

13. Li, C.; Hu, M.; Li, Y.; Jiang, H.; Ge, N.; Montgomery, E.; Zhang, J.; Song, W.; Dávila, N.; Graves, C. E.; Li, Z.; Strachan, J. P.; Lin, P.; Wang, Z.; Barnell, M.; Wu, Q.; Williams, R. S.; Yang, J. J.; Xia, Q., Analogue signal and image processing with large memristor crossbars. Nature Electronics 2018, 1, 52-59.

14. Eryilmaz, S. B.; Kuzum, D.; Jeyasingh, R.; Kim, S.; BrightSky, M.; Lam, C.; Wong, H.-S. P., Brain-like associative learning using a nanoscale non-volatile phase change synaptic device array. Frontiers in neuroscience 2014, 8, 205.

15. Wong, H.-S. P.; Raoux, S.; Kim, S.; Liang, J.; Reifenberg, J. P.; Rajendran, B.; Asheghi, M.; Goodson, K. E., Phase change memory. Proceedings of the IEEE 2010, 98, 2201-2227.

16. Tuma, T.; Pantazi, A.; Le Gallo, M.; Sebastian, A.; Eleftheriou, E., Stochastic phase-change neurons. Nature nanotechnology 2016, 11, 693.

17. Zhu, L. Q.; Wan, C. J.; Guo, L. Q.; Shi, Y.; Wan, Q., Artificial synapse network on inorganic proton conductor for neuromorphic systems. Nature communications 2014, 5, 3158.

18. Sangwan, V. K.; Lee, H.-S.; Bergeron, H.; Balla, I.; Beck, M. E.; Chen, K.-S.; Hersam, M. C., Multi-terminal memtransistors from polycrystalline monolayer molybdenum disulfide. Nature 2018, 554, 500.

19. Locatelli, N.; Cros, V.; Grollier, J., Spin-torque building blocks. Nature materials 2014, 13, 11.

20. Yu, G.; Upadhyaya, P.; Shao, Q.; Wu, H.; Yin, G.; Li, X.; He, C.; Jiang, W.; Han, X.; Amiri, P. K.; Wang, K. L., Room-Temperature Skyrmion Shift Device for Memory Application. Nano letters 2017, 17, 261-268.

21. Shao, Q.; Yu, G.; Lan, Y.-W.; Shi, Y.; Li, M.-Y.; Zheng, C.; Zhu, X.; Li, L.-J.; Amiri, P. K.; Wang, K. L., Strong Rashba-Edelstein Effect-Induced Spin-Orbit Torques in Monolayer Transition Metal Dichalcogenide/Ferromagnet Bilayers. Nano letters 2016, 16, 7514-7520.

22. Chanthbouala, A.; Garcia, V.; Cherifi, R. O.; Bouzehouane, K.; Fusil, S.; Moya, X.; Xavier, S.; Yamada, H.; Deranlot, C.; Mathur, N. D., A ferroelectric memristor. Nature materials 2012, 11, 860.

23. Boyn, S.; Grollier, J.; Lecerf, G.; Xu, B.; Locatelli, N.; Fusil, S.; Girod, S.; Carrétéro, C.; Garcia, K.; Xavier, S., Learning through ferroelectric domain dynamics in solid-state synapses. Nature communications 2017, 8, 14736.

24. Pershin, Y. V.; Di Ventra, M., Memory effects in complex materials and nanoscale systems. Advances in Physics 2011, 60, 145-227.

25. Wong, H.-S. P.; Lee, H.-Y.; Yu, S.; Chen, Y.-S.; Wu, Y.; Chen, P.-S.; Lee, B.; Chen, F. T.; Tsai, M.-J., Metal-oxide RRAM. Proceedings of the IEEE 2012, 100, 1951-1970.

26. van de Burgt, Y.; Lubberman, E.; Fuller, E. J.; Keene, S. T.; Faria, G. C.; Agarwal, S.; Marinella, M. J.; Talin, A. A.; Salleo, A., A non-volatile organic electrochemical device as a low-voltage artificial synapse for neuromorphic computing. Nature materials 2017, 16, 414.

27. Xuan, Y.; Sandberg, M.; Berggren, M.; Crispin, X., An all-polymer-air PEDOT battery. Org Electron 2012, 13, 632-637.

28. van de Burgt, Y.; Melianas, A.; Keene, S. T.; Malliaras, G.; Salleo, A., Organic electronics for neuromorphic computing. Nature Electronics 2018, 1.

29. Gkoupidenis, P.; Schaefer, N.; Garlan, B.; Malliaras, G. G., Neuromorphic Functions in PEDOT:PSS Organic Electrochemical Transistors. Adv Mater 2015, 27, 7176-80.

30. Gkoupidenis, P.; Koutsouras, D. A.; Malliaras, G. G., Neuromorphic device architectures with global connectivity through electrolyte gating. Nature communications 2017, 8, 15448.

31. Wu, C.; Kim, T. W.; Choi, H. Y.; Strukov, D. B.; Yang, J. J., Flexible three-dimensional artificial synapse networks with correlated learning and trainable memory capability. Nature communications 2017, 8, 752.

32. Cao, X.; Lau, C.; Liu, Y.; Wu, F.; Gui, H.; Liu, Q.; Ma, Y.; Wan, H.; Amer, M. R.; Zhou, C., Fully screen-printed, large-area, and flexible active-matrix electrochromic displays using carbon nanotube thin-film transistors. ACS nano 2016, 10, 9816-9822.

33. Fukuda, K.; Takeda, Y.; Yoshimura, Y.; Shiwaku, R.; Tran, L. T.; Sekine, T.; Mizukami, M.; Kumaki, D.; Tokito, S., Fully-printed high-performance organic thin-film transistors and circuitry on one-micron-thick polymer films. Nature communications 2014, 5, 4147.

34. Bliss, T. V. P.; Collingridge, G. L., A synaptic model of memory: long-term potentiation in the hippocampus. Nature 1993, 361, 31.

35. Abbott, L. F.; Nelson, S. B., Synaptic plasticity: taming the beast. Nature neuroscience 2000, 3, 1178.

36. Zucker, R. S.; Regehr, W. G., Short-term synaptic plasticity. Annual review of physiology 2002, 64, 355-405.

37. Nangate Inc Nangate 45 nm Open Library. http://www.nangate.com/.

38. Bache, K., Lichman, M., UCI Machine Learning Repository (University of California, School of Information and Computer Science, 2016).

39. Deng, L., The MNIST database of handwritten digit images for machine learning research [best of the web]. IEEE Signal Processing Magazine 2012, 29, 141-142.

40. AT&T laboratories cambridge ORL database of faces. 2002.

41. Rubiolo, M.; Stegmayer, G.; Milone, D., Compressing arrays of classifiers using Volterra-neural network: application to face recognition. Neural Computing and Applications 2013, 23, 1687-1701.

What is claimed is:

1. A neuromorphic device comprising:
a substrate;
a patterned electrical contact disposed on the substrate, the patterned electrical contact defining a presynaptic contact section, a first post-synaptic contact section, and a second post-synaptic contact section, wherein the presynaptic contact section, the first post-synaptic contact section, and the second post-synaptic contact section are electrically separated from each other,
a patterned layer of an electrically conductive polymer having a first polymeric section disposed over a portion of the presynaptic contact section and a second polymeric section disposed over the first post-synaptic contact section and the second post-synaptic contact section, the electrically conductive polymer having an electrical conductivity that can be tuned by localization or delocalization of electrons therein, the first polymeric section and the second polymeric section being separated to define a gap; and
a polyelectrolyte layer disposed over the both the first polymeric section and the second polymeric section and at least partially filling the gap, wherein when no voltage is applied to the presynaptic contact section the neuromorphic device is in a low electrical conductivity state and when a positive voltage is applied to the presynaptic contact section the neuromorphic device switches to a high electrical conductivity state.

2. The neuromorphic device of claim 1 wherein the polyelectrolyte layer is polydiallyldimethyl-ammonium chloride.

3. The neuromorphic device of claim 1 wherein the patterned layer of an electrically conductive polymer is a polymeric salt.

4. The neuromorphic device of claim 1 wherein the patterned layer of an electrically conductive polymer is poly(3,4-ethylene dioxythiophene):polystyrene sulfonate.

5. The neuromorphic device of claim 1 wherein the substrate is a flexible polymeric substrate.

6. The neuromorphic device of claim 1 wherein a negative voltage applied to the presynaptic contact section causes the neuromorphic device to return to the low electrical conductivity state after a positive voltage has been applied.

7. An array of neuromorphic devices, each neuromorphic device comprising:
a substrate;
a patterned electrical contact disposed on the substrate, the patterned electrical contact defining a presynaptic contact section, a first post-synaptic contact section, and a second post-synaptic contact section, wherein the presynaptic contact section, the first post-synaptic contact section, and the second post-synaptic contact section are electrically separated from each other,
a patterned layer of an electrically conductive polymer having a first polymeric section disposed over a portion of the presynaptic contact section and a second polymeric section disposed over the first post-synaptic contact section and the second post-synaptic contact section, the electrically conductive polymer having an electrical conductivity that can be tuned by localization or delocalization of electrons therein, the first polymeric section and the second polymeric section being separated to define a gap; and
a polyelectrolyte layer disposed over the both the first polymeric section and the second polymeric section and at least partially filling the gap, wherein when no voltage is applied to the presynaptic contact section the neuromorphic device is in a low electrical conductivity state and when a positive voltage is applied to the presynaptic contact section the neuromorphic device switches to a high electrical conductivity state.

8. The array of neuromorphic devices of claim 7 wherein a subset of the array of neuromorphic devices are connected in parallel.

9. The array of neuromorphic devices of claim 7 wherein a subset of the array of neuromorphic devices are connected in series.

10. The array of neuromorphic devices of claim 7 wherein the polyelectrolyte layer is polydiallyldimethyl-ammonium chloride.

11. The array of neuromorphic devices of claim 7 wherein the patterned layer of an electrically conductive polymer is a polymeric salt.

12. The array of neuromorphic devices of claim 7 wherein the patterned layer of an electrically conductive polymer is poly(3,4-ethylene dioxythiophene):polystyrene sulfonate.

13. The array of neuromorphic devices of claim 7 wherein the substrate is a flexible polymeric substrate.

14. A method for making a neuromorphic device, the method comprising:
screen-printing a patterned electrical contact on a substrate, wherein the patterned electrical contact defines a presynaptic contact section, a first post-synaptic contact section, and a second post-synaptic contact section and wherein the presynaptic contact section, the first post-synaptic contact section, and the second post-synaptic contact section are electrically separated from each other;
screen-printing a patterned layer of an electrically conductive polymer such that a first polymeric section is screen-printed over a portion of the presynaptic contact section and a second polymeric section is screen printed over the first post-synaptic contact section and the second post-synaptic contact section, the first polymeric section and the second polymeric section being separated to define a gap; and
screen-printing a polyelectrolyte layer over the both the first polymeric section and the second polymeric section wherein the gap is at least partially filled.

15. The method of claim 14 wherein the polyelectrolyte layer is polydiallyldimethyl-ammonium chloride.

16. The method of claim 14 wherein the patterned layer of an electrically conductive polymer is a polymeric salt.

17. The method of claim 14 wherein the patterned layer of an electrically conductive polymer is poly(3,4-ethylene dioxythiophene):polystyrene sulfonate.

18. The method of claim 14 wherein the substrate is a flexible polymeric substrate.

19. The method of claim 14 further comprising forming an array of neuromorphic devices.
